(19) United States
(12) Patent Application Publication
(10) Pub. No.: US 2015/0267761 A1
(43) Pub. Date: Sep. 24, 2015

(54) MULTIPLE DISC CLUTCH DEVICE FOR VEHICLE

(71) Applicant: Toyota Jidosha Kabushiki Kaisha, Toyota-shi Aichi-ken (JP)

(72) Inventor: Takahiro Yoshimura, Toyota-shi Aichi-ken (JP)

(21) Appl. No.: 14/661,260

(22) Filed: Mar. 18, 2015

(30) Foreign Application Priority Data
Mar. 20, 2014 (JP) 2014-059060

(51) Int. Cl. F16D 27/115; F16D 13/70; B60K 17/35; F16D 13/52

(52) U.S. Cl. CPC F16D 27/115; F16D 13/52; F16D 13/70; B60K 17/35

(57) ABSTRACT

A reaction member is arranged on one side of a main clutch in a direction of a rotation axis. The reaction member is configured to generate a reaction force by receiving a pressing force in the direction of the rotation axis via the main clutch, the pressing force being applied from the other side of the main clutch in the direction of the rotation axis. A reaction member actuating device is configured to position the reaction member between a reaction force generating position for causing the reaction member to generate the reaction force and a non-reaction force generating position. The non-reaction force generating position is farther from the main clutch than the reaction force generating position and a position that is located a predetermined distance apart from the reaction force generating position in the direction of the rotation axis.

### INCORPORATION BY REFERENCE

The disclosure of Japanese Patent Application No. 2014-059060 filed on Mar. 20, 2014 including the specification, drawings and abstract is incorporated herein by reference in its entirety.

### BACKGROUND OF THE INVENTION

1. Field of the Invention

The invention relates to a multiple disc clutch device for a vehicle, which is provided in a power transmission path of the vehicle and which executes control for connecting or interrupting the power transmission path.

2. Description of Related Art

There is known a multiple disc clutch device for a vehicle, which is provided in a power transmission path of the vehicle and which controls a driving force that is transmitted to the transmission path. This is, for example, a multiple disc clutch device for a vehicle, described in Japanese Patent Application Publication No. 2002-364677 (JP 2002-364677 A).

Such a multiple disc clutch device for a vehicle, for example, includes a clutch drum, a multiple disc main clutch and a cam amplification mechanism. The clutch drum is integrally coupled to one of an input shaft and an output shaft. The multiple disc main clutch is provided inside the clutch drum between the clutch drum and the other one of the input shaft and the output shaft. The cam amplification mechanism drives a piston. The piston converts torque, generated in an electromagnetic pilot clutch, to thrust torque, amplifies the thrust torque, and presses the main clutch. The thus configured multiple disc electromagnetic clutch is able to output a relatively large transmission torque according to an exciting current of an electromagnet. Thus, for example, the multiple disc electromagnetic clutch is arranged in a propeller shaft, an axle, or the like, and is used to control the torque of driven wheels of a 4WD vehicle or the turning behavior of the 4WD vehicle.

### SUMMARY OF THE INVENTION

Incidentally, in the multiple disc clutch device shown in FIG. 1 of JP 2002-364677 A, the main clutch is of a multiple disc clutch in which a plurality of inner clutch plates and a plurality of outer clutch plates are alternately stacked each other. In order to ensure responsiveness, each adjacent pair of inner clutch plate and outer clutch plate that constitute the main clutch is arranged in proximity to each other via an oil film. Thus, the multiple disc clutch device has such a characteristic that a drag torque is relatively large when the main clutch is not activated and the drag torque further increases as the temperature decreases. Therefore, in the vehicle, there is a possibility that the effect of improving fuel economy is not sufficiently obtained because of the drag torque. When the main clutch is not activated, the multiple disc clutch device is placed in a fully differential state, and there is a large rotation difference between the inner clutch plates and the outer clutch plates. Therefore, there is a possibility that the durability of the multiple disc clutch device is not sufficiently obtained.

For example, it is conceivable that the above-described multiple disc clutch device is used as a disconnect device in a four-wheel drive vehicle. The four-wheel drive vehicle includes main drive wheels and auxiliary drive wheels. The main drive wheels are used as drive wheels both in a four-wheel drive mode and a two-wheel drive mode. Driving force is not transmitted to the auxiliary drive wheels in the two-wheel drive mode. The disconnect device is used to select between the four-wheel drive mode and the two-wheel drive mode. The multiple disc clutch device is used at one end of any one of power transmission members in a path from a transfer to the auxiliary drive wheels. The transfer splits part of driving torque, which is output from a transmission output shaft, to the auxiliary drive wheels. In this case, because there is a large rotation difference between the transmission output shaft and the auxiliary drive wheels in the two-wheel drive mode of the vehicle, the drag torque of the multiple disc clutch device is large, so there is a possibility that the effect of improving fuel economy of the vehicle is not sufficiently obtained. In the two-wheel drive mode, there is also a possibility that the multiple disc clutch device is placed in the fully differential state and, as a result, the durability is not sufficiently ensured.

In contrast, it is conceivable that a disconnect mechanism is additionally provided in the above-described electromagnetic pilot clutch device. The disconnect mechanism is formed of an intermesh clutch that disconnects the transmission output shaft from the auxiliary drive wheels in the two-wheel drive mode. However, in such a case, there is a possibility that a driving force transmission device of the vehicle becomes complicated and large.

The invention provides a multiple disc clutch device for a vehicle, which generates a small drag torque when a clutch is not activated.

A first aspect of the invention provides a multiple disc clutch device for a vehicle. The vehicle includes a first rotor and a second rotor. The first rotor is arranged in a power transmission path of the vehicle. The second rotor is arranged in the power transmission path of the vehicle. The multiple disc clutch device is arranged in the power transmission path of the vehicle so as to connect the first rotor to the second rotor or disconnect the first rotor from the second rotor. The multiple disc clutch device includes a clutch drum, an inner shaft, a main clutch, a reaction member, and a reaction member actuating device. The clutch drum is provided so as to rotate around a rotation axis. The clutch drum is coupled to the first rotor. The inner shaft is provided inside the clutch drum. The inner shaft is provided so as to relatively rotate around the rotation axis with respect to the clutch drum. The inner shaft is coupled to the second rotor. The main clutch is provided such that an outer clutch plate and an inner clutch plate are alternately stacked each other. The outer clutch plate is provided on an inner periphery of the clutch drum so as not to relatively rotate with respect to the clutch drum. The inner clutch plate is provided on an outer periphery of the inner shaft so as not to relatively rotate with respect to of the inner shaft. The reaction member is arranged on one side of the main clutch in a direction of the rotation axis. The reaction member is configured to generate a reaction force by receiving a pressing force in the direction of the rotation axis via the main clutch. The pressing force is applied from the other side of the main clutch in the direction of the rotation axis. The reaction member actuating device is configured to position the reaction member between a reaction force generating position for causing the reaction member to generate the reaction force and a non-reaction force generating position. The non-reaction force generating position is farther from the main clutch (84) than the reaction force generating position. The non-reaction force generating position is a position that is located a predetermined distance apart from the reaction force generating position in the direction of the rotation axis away from the main clutch.

According to the above aspect, the reaction member that sandwiches the main clutch in cooperation with the torque control piston that presses the main clutch by the torque control actuator is configured to be positioned by the reaction member actuating device between the reaction force generating position and the non-reaction force generating position. Thus, when the reaction member is located at the non-reaction force generating position at the time the main clutch is not activated, the drag torque of the multiple disc clutch device is significantly reduced when the main clutch is not activated. At the non-reaction force generating position, the reaction member is located the predetermined distance apart from the main clutch in the axial direction by the reaction member actuating device. Thus, the fuel efficiency of the vehicle improves and, even when the multiple disc clutch device is placed in the fully differential state when the main clutch is not activated and, as a result, there is a large rotation difference, the durability of the multiple disc clutch device is ensured.

In the above aspect, the reaction member actuating device may include a first electromagnet, a first electromagnetic pilot clutch, a first thrust conversion mechanism, and a trip mechanism. The first electromagnetic pilot clutch may be configured to generate a pilot torque when first friction plates are pressed by a first movable piece. The first friction plates may be provided between the clutch drum and the inner shaft so as to be stacked each other. The first movable piece may be attracted by the first electromagnet. The first thrust conversion mechanism may be configured to convert the pilot torque generated by the first electromagnetic pilot clutch to a thrust in the direction of the rotation axis, amplify the thrust and output the amplified thrust. The trip mechanism may be configured to move the reaction member to the reaction force generating position as a result of a predetermined number of inputs of the thrust from the first thrust conversion mechanism and then latch the reaction member at the reaction force generating position. The trip mechanism may be configured to, when the number of inputs of the thrust exceeds the predetermined number, unlatch the reaction member and then move the reaction member to the non-reaction force generating position. According to the above aspect, as a result of multiple strokes of the first reciprocating member that moves together with the first movable piece that is attracted by the first electromagnet, the second reciprocating member and the reaction member that moves together with the second reciprocating member are moved by a stroke longer than the stroke of the first reciprocating member. Thus, the stroke between the reaction force generating position and non-reaction force generating position of the reaction member that receives the reaction force of the main clutch is significantly elongated. Therefore, the clearance between the reaction member and the main clutch and the clearance between the outer clutch plate and the inner clutch plate are increased when the main clutch is not activated. The outer clutch plate and the inner clutch plate constitute the main clutch of which the reaction force is received by the reaction member, and are stacked each other. Thus, the drag torque is significantly reduced. The first electromagnet that attracts the first movable piece by a relatively small stroke has a relatively small axial length and a relatively small radial size. Thus, the size of the reaction member actuating device that functions as an actuator for the reaction member is reduced, so the mountability of the multiple disc clutch device on the vehicle is improved.

In the above aspect, the trip mechanism may include a first reciprocating member, a second reciprocating member, a return spring, and a latch member. The first reciprocating member may be configured to reciprocate in a thrust direction together with the first movable piece. The second reciprocating member may be configured to be actuated in the thrust direction by being pressed by the first reciprocating member. The return spring may be configured to urge the second reciprocating member toward the first reciprocating member. The latch member may have multi-step latch teeth. The latch member may be provided so as not to relatively rotate with respect to the inner shaft and so as not to move in the direction of the rotation axis. The latch member may be configured to latch the second reciprocating member at a predetermined stroke end with any one of the multi-step latch teeth each time the first reciprocating member is moved. The latch member may be configured to latch the second reciprocating member as a result of a predetermined number of movements of the first reciprocating member such that the reaction member coupled to the second reciprocating member is located at the reaction force generating position. The latch member may be configured to unlatch the second reciprocating member as a result of a predetermined number of movements of the first reciprocating member and cause the reaction member to be located at the non-reaction force generating position under an urging force of the return spring. According to the above aspect, the trip mechanism is formed of the first reciprocating member, the second reciprocating member, the return spring, and the latch member. Thus, the size of the multiple disc clutch device is reduced, so the mountability of the multiple disc clutch device on the vehicle is improved.

In the above aspect, the multiple disc clutch device may further include a torque control piston and a torque control actuator. The torque control piston may be provided such that the main clutch is located between the torque control piston and the reaction member in the direction of the rotation axis. The torque control piston may be configured to clamp the main clutch in cooperation with the reaction member. The torque control actuator may be configured to control a transmission torque by applying a thrust to the torque control piston. The main clutch may be configured to generate the transmission torque by being clamped by the torque control piston and the reaction member located at the reaction force generating position. According to the above aspect, the main clutch is clamped by the torque control piston and the reaction member located at the reaction force generating position. The thrust of the torque control piston is controlled by the torque control actuator. Thus, there is an advantage in that the transmission torque of the multiple disc clutch device is controlled to a desired torque.

In the above aspect, the torque control actuator may include a second electromagnet, a second electromagnetic pilot clutch, and a second thrust conversion mechanism. The second electromagnetic pilot clutch may be configured to generate a pilot torque when second friction plates are pressed by a second movable piece that is attracted by the second electromagnet, the second friction plates may be provided between the clutch drum and the inner shaft so as to be stacked each other. The second thrust conversion mechanism may be configured to convert the pilot torque generated by the second electromagnetic pilot clutch to a thrust in the direction of the rotation axis, amplify the thrust and transmit the amplified thrust to the torque control piston. According to the above aspect, because the size of the torque control actuator is reduced, the size of the multiple disc clutch device is reduced, so the mountability of the multiple disc clutch device on the vehicle is improved.

A second aspect of the invention provides a vehicle. The vehicle includes a first driving force distribution unit, a transfer, a second driving force distribution unit, and a multiple disc clutch device. The first driving force distribution unit is configured to transmit a driving force from a driving source to right and left main drive wheels. The transfer is provided in the first driving force distribution unit. The transfer is configured to output power to right and left auxiliary drive wheels. The second driving force distribution unit is configured to transmit power to the right and left auxiliary drive wheels. The power is input via a propeller shaft coupled to the transfer. The multiple disc clutch device is arranged in a power transmission path from the transfer to at least one of the right and left auxiliary drive wheels. According to the above aspect, in the two-wheel drive mode, the multiple disc clutch device is not activated, with the result that the auxiliary drive wheels and the engine are not coupled to each other (are disconnected from each other). Thus, the fuel efficiency of the vehicle improves. In the four-wheel drive mode, the multiple disc clutch device is not activated, and the transmission torque is controlled, with the result that the behavior of the vehicle in, for example, cornering is stably controlled.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a skeletal view that schematically shows the configuration of a powertrain of a four-wheel drive vehicle to which a multiple disc clutch for a vehicle according to an embodiment of the invention is applied;

FIG. 2 is an enlarged cross-sectional view that illustrates the configuration of the multiple disc clutch shown in FIG. 1; and

FIG. 3 is a developed plan that illustrates latch teeth of a trip mechanism provided in the multiple disc clutch shown in FIG. 1 and FIG. 2.

### DETAILED DESCRIPTION OF EMBODIMENTS

Hereinafter, an embodiment of the invention will be described in detail with reference to the accompanying drawings. In the following embodiment, the drawings are modified or simplified where appropriate, and the scale ratio, shape, and the like, of each portion are not always drawn accurately.

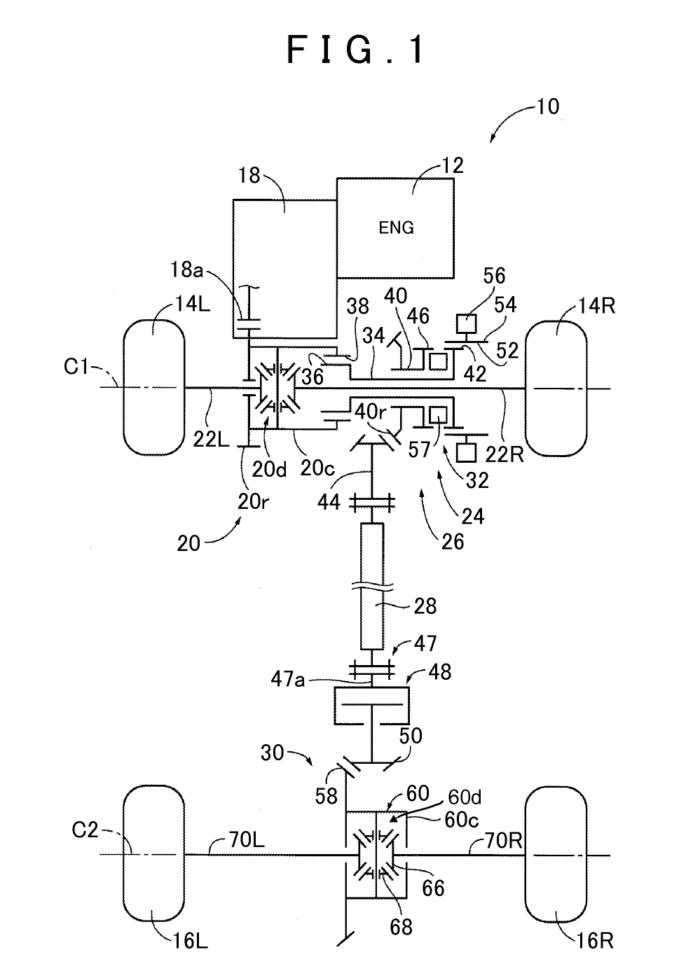

FIG. 1 is a skeletal view that schematically illustrates the configuration of a four-wheel drive vehicle 10 to which the invention is suitably applied. As shown in FIG. 1, the four-wheel drive vehicle 10 uses an engine 12 as a driving source, and includes an FF-base four-wheel drive system including a first power transmission path and a second power transmission path. The first power transmission path transmits power from the engine 12 to right and left front wheels 14R, 14L corresponding to main drive wheels. The second power transmission path transmits power from the engine 12 to right and left rear wheels 16R, 16L corresponding to auxiliary drive wheels. In a two-wheel drive mode of the four-wheel drive vehicle 10, a driving force transmitted from the engine 12 via an automatic transmission 18 is transmitted to the right and left front wheels 14R, 14L via a front wheel (main drive wheel) driving force distribution unit 26 and right and left axles 22R, 22L. In the two-wheel drive mode, at least an intermesh first clutch 32 provided in a transfer 24 is released. Thus, power output from the automatic transmission 18 is not transmitted to the transfer 24, a propeller shaft 28, a rear wheel driving force distribution unit 30 and the rear wheels 16R, 16L. However, in a four-wheel drive mode, as the intermesh first clutch 32 is engaged, a second clutch 48 provided on a drive pinion 50 is engaged at the same time. Thus, power output from the automatic transmission 18 is transmitted to a right axle 70R and the right rear wheel 16R and a left axle 70L and the left rear wheel 16L via a differential gear unit 20. Thus, the four-wheel drive vehicle 10 travels in the four-wheel drive mode. Although not shown in FIG. 1, a fluid transmission device, such as a torque converter, or a clutch is provided between the engine 12 and the automatic transmission 18.

The automatic transmission 18 is, for example a stepped automatic transmission. The stepped automatic transmission includes a plurality of planetary gear trains and friction engagement devices (a clutch and a brake). A speed position of the stepped automatic transmission is selected by selectively engaging those friction engagement devices. Alternatively, the automatic transmission 18 may be a stepped automatic transmission in which a speed position of a constant mesh parallel shaft transmission is selected by a shift actuator and a select actuator. Alternatively, the automatic transmission 18 may be a continuously variable transmission of which a speed ratio is continuously changed by changing the effective diameters of a pair of variable pulleys having variable effective diameters and around which a transmission belt is wound. Because the automatic transmission 18 is a known technique, the description of specific structure and operation is omitted.

The front wheel driving force distribution unit 26 includes a first differential gear unit 20 and the transfer 24. The transfer 24 includes the first clutch 32. The first differential gear unit 20 includes a differential case 20c, a ring gear 20r and a differential gear mechanism 20d. The differential case 20c is provided so as to be rotatable around a rotation axis C1. The ring gear 20r is fixed to the differential case 20c, and is in mesh with an output gear 18a of the automatic transmission 18. The differential gear mechanism 20d is accommodated in the differential case 20c, and includes a pair of side gears and pinions. The pair of side gears are respectively coupled to the right and left axles 22R, 22L. The pinions are in mesh with the pair of side gears, and are supported by the differential case 20c so as to be rotatable around a rotation axis perpendicular to the rotation axis C1. The first differential gear unit 20 transmits a driving force to the right and left axles 22R, 22L of the front wheels 12R, 12L while allowing differential rotation between the right and left axles 22R, 22L. Internal teeth 38 are provided on the differential case 20c. The internal teeth 38 are in mesh with external teeth 36. The external teeth are provided at a shaft end of a cylindrical first rotary shaft 34 of the transfer 24. Thus, the transfer 24 is coupled to the differential case 20c of the front wheel driving force distribution unit 26. The transfer 24 transmits part of the driving force, output from the engine 12, to the rear wheels 16.

The first clutch 32 provided in the transfer 24 is formed of an intermesh dog clutch, and includes the cylindrical first rotary shaft 34, a cylindrical second rotary shaft 40, a cylindrical sleeve 54, a synchromesh mechanism 57 and a first clutch actuator 56. The cylindrical first rotary shaft 34 functions as an input member. The cylindrical second rotary shaft 40 functions as an output member. The cylindrical sleeve 54 has internal teeth 52, and is provided so as to be movable in the direction of the rotation axis C1 in a state where the sleeve 54 is constantly in mesh with external teeth 42 of the first rotary shaft 34 in order to couple the external teeth 42 to external teeth 46 of the second rotary shaft 40. The synchromesh mechanism 57 mechanically synchronizes rotation of the sleeve 54 with rotation of the external teeth 46 at the time of engagement. The first clutch actuator 56 actuates the sleeve 54. FIG. 1 shows a state where the first clutch 32 is released.

In the transfer 24, as a result of engagement of the first clutch 32, the first rotary shaft 34 coupled to the differential case 20c and the second rotary shaft 40 having a ring gear 40r are integrally rotated. Thus, part of the driving force input from the differential case 20c is output to the front end of the propeller shaft 28 via a driven pinion 44 that is in mesh with the ring gear 40r.

The rear wheel driving force distribution unit 30 includes the second clutch 48, the drive pinion 50 and a differential gear unit 60. The second clutch 48 is coupled to the rear end of the propeller shaft 28 via a joint 47. The drive pinion 50 is coupled to the propeller shaft 28 via the joint 47 and the second clutch 48. The differential gear unit 60 has a ring gear 58 that is in mesh with the drive pinion 50, and distributes the transmitted driving force to the right and left drive wheels. The differential gear unit 60 includes a differential case 60c and a differential gear mechanism 60d. The differential case 60c is provided so as to be rotatable around a rotation axis C2. The ring gear 58 is fixed to the differential case 60c. The differential gear mechanism 60d is accommodated in the differential case 60c, and includes a pair of side gears 66 and pinions 68. The pair of side gears 66 are respectively coupled to the right and left axles 70R, 70L. The pinions 68 are supported by the differential case 60c so as to be rotatable around a rotation axis perpendicular to the rotation axis C2. The differential gear unit 60 transmits a driving force to the right and left axles 70R, 70L of the rear wheels 16R, 16L while allowing differential rotation between the right and left axles 70R, 70L.

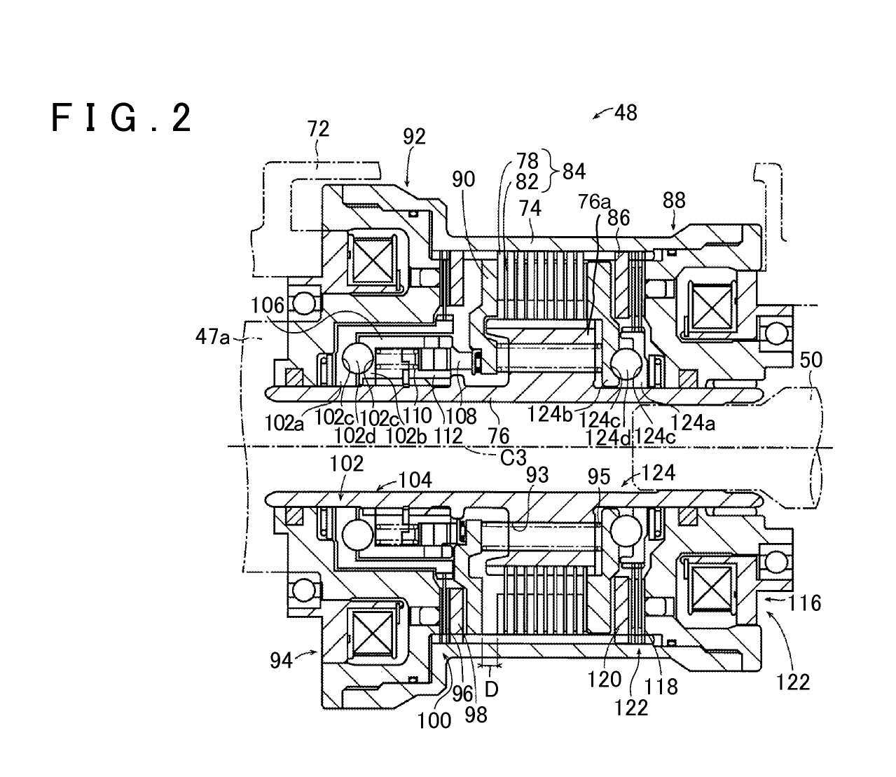

The second clutch 48 is an example of a multiple disc clutch device having both the function of a disconnect clutch and the function of an electronically controlled coupling. The function of the disconnect clutch is to improve fuel efficiency by disconnecting power transmission members from the rear wheels 16R, 16L in the two-wheel drive mode in which the first clutch 32 is released. The power transmission members include, for example, the propeller shaft 28, and are used to transmit power to the rear wheels 16R, 16L. The function of the electronically controlled coupling is to control the distribution ratio of driving torque between the front and rear wheels in order to stabilize the behavior of the vehicle in cornering, or the like. FIG. 2 is a cross-sectional view that shows the configuration of the second clutch 48 in details. The second clutch 48 is accommodated in a clutch housing 72 in a state where part of the second clutch 48 is immersed in lubricating oil (not shown). The clutch housing 72 is a non-rotating member fixed to a housing of the rear wheel driving force distribution unit 30. A main clutch 84 is lubricated through a through-hole (not shown) provided in a clutch drum 74. That is, the main clutch 84 is a wet multiple disc clutch.

As shown in FIG. 2, the second clutch 48 includes the large-diameter cylindrical clutch drum 74, a cylindrical inner shaft 76, the multiple disc main clutch 84 and a torque control actuator 88. The large-diameter cylindrical clutch drum 74 is provided so as to be rotatable around a rotation axis C3. The cylindrical inner shaft 76 is provided concentrically inside the clutch drum 74 so as to be relatively rotatable around the rotation axis C3 with respect to the clutch drum 74. The inner shaft 76 extends through the clutch drum 74 in the direction of the rotation axis C3. The multiple disc main clutch 84 is provided such that a plurality of annular outer clutch plates 78 and a plurality of annular inner clutch plates 82 are alternately stacked each other. The outer clutch plates 78 are provided so as to be relatively non-rotatable with respect to the inner periphery of the clutch drum 74 because of spline fitting and movable in the direction of the rotation axis C3. The inner clutch plates 82 are provided so as to be relatively non-rotatable with respect to the outer periphery of a clutch hub 76a because of spline fitting and movable in the direction of the rotation axis C3. The clutch hub 76a is provided at the middle portion of the inner shaft 76 so as to have a large diameter. The torque control actuator 88 is located at a side across the main clutch 84 from a reaction member 90, and includes a torque control piston 86. The torque control piston 86 is used to clamp the main clutch 84 in cooperation with the reaction member 90. The second clutch 48 controls a driving torque that is transmitted between a joint member (first rotor) 47a and the drive pinion (second rotor) 50 in the power transmission path of the vehicle from the transfer 24 to the differential gear unit 60. The joint member 47a constitutes the joint 47 to which the clutch drum 74 is coupled so as to be relatively non-rotatable. The inner shaft 76 is coupled to the drive pinion 50 so as to be relatively non-rotatable.

The second clutch 48 includes the reaction member 90 and a reaction member actuating device 92. The reaction member 90 clamps the main clutch 84 in cooperation with the torque control piston 86 as follows. The reaction member 90 contacts the main clutch 84 and receives a pressing force at a reaction force generating position. The pressing force is applied from the torque control piston 86 to the main clutch 84. The reaction force generating position is located at a side across the main clutch 84 from the torque control piston 86. The reaction member actuating device 92 positions the reaction member 90 between the reaction force generating position and a non-pressing force receiving position. The non-pressing force receiving position is a position at which the reaction member 90 is located a predetermined distance D apart from the reaction force generating position away from the main clutch 84. Return springs 95 are arranged between the torque control piston 86 and the reaction member 90. The return springs 95 are respectively inserted through holes 93. The holes 93 are provided so as to extend through the clutch hub 76a in a direction parallel to the rotation axis C3. The torque control piston 86 and the reaction member 90 are constantly urged in a direction away from each other, that is, a direction to move away from the main clutch 84.

The reaction member actuating device 92 includes an annular first electromagnet 94, a first electromagnetic pilot clutch 100, a first thrust conversion mechanism 102 and a trip mechanism 104. The annular first electromagnet 94 is fixed to the clutch housing 72 that is a non-rotating member. The first electromagnetic pilot clutch 100 generates a pilot torque in the following manner. A plurality of friction plates 96 are pressed by a first movable piece 98 that is attracted by the first electromagnet 94. The plurality of friction plates 96 are provided between the clutch drum 74 and the inner shaft 76 so as to be stacked each other. The first thrust conversion mechanism 102 converts the pilot torque, generated by the first electromagnetic pilot clutch 100, to a thrust in the direction of the rotation axis C3, and outputs the thrust. The trip mechanism 104 contacts the main clutch 84, moves the reaction member 90 to the reaction force generating position as a result of a predetermined number of inputs of the thrust from the first thrust conversion mechanism 102, and latches the reaction member 90 at a pressing force receiving position. When the number of inputs of the thrust exceeds the predetermined number, the trip mechanism 104 unlatches the reaction member 90, and moves the reaction member 90 to a non-reaction force generating position. Thus, the pilot torque that is generated in response to pressing of the first movable piece 98 that is attracted by the first electromagnet 94 is converted to the thrust in the direction of the rotation axis C3. The reaction member 90 is latched each time the thrust is input, and, when the number of inputs of the thrust exceeds the predetermined number, the reaction member 90 is unlatched and moved to the non-reaction force generating position. Because the reaction member 90 is allowed to be moved by a long stroke, a stroke D between the reaction receiving position and non-reaction receiving position of the reaction member 90 that receives a reaction force from the main clutch 84 is significantly elongated.

The first thrust conversion mechanism 102 includes an input-side annular member 102a, an output-side annular member 102b and spherical rolling elements 102d. The input-side annular member 102a is provided so as to be rotatable around the rotation axis C3. A pilot torque that is generated from the first electromagnetic pilot clutch 100 in response to excitation of the first electromagnet 94 is transmitted to the input-side annular member 102a. The output-side annular member 102b is spline-fitted to the outer periphery of the inner shaft 76 so as to be relatively non-rotatable and movable in the direction of the rotation axis C3. Each of the spherical rolling elements 102d is sandwiched by those input-side annular member 102a and output-side annular member 102b in a state where part of the spherical rolling element 102d is accommodated in a corresponding pair of inclined cam grooves 102c. The inclined cam grooves 102c are provided on each of facing surfaces of those input-side annular member 102a and output-side annular member 102b. The groove bottom depth of each inclined cam groove 102c continuously changes in the circumferential direction. When the input-side annular member 102a and the output-side annular member 102b are relatively rotated as a result of transmission of the pilot torque from the first electromagnetic pilot clutch 10, the output-side annular member 102b is moved in the direction of the rotation axis C3, and outputs a thrust in the thrust direction. The first thrust conversion mechanism 102 repeatedly actuates the trip mechanism 104 in response to excitation of the first electromagnet 94.

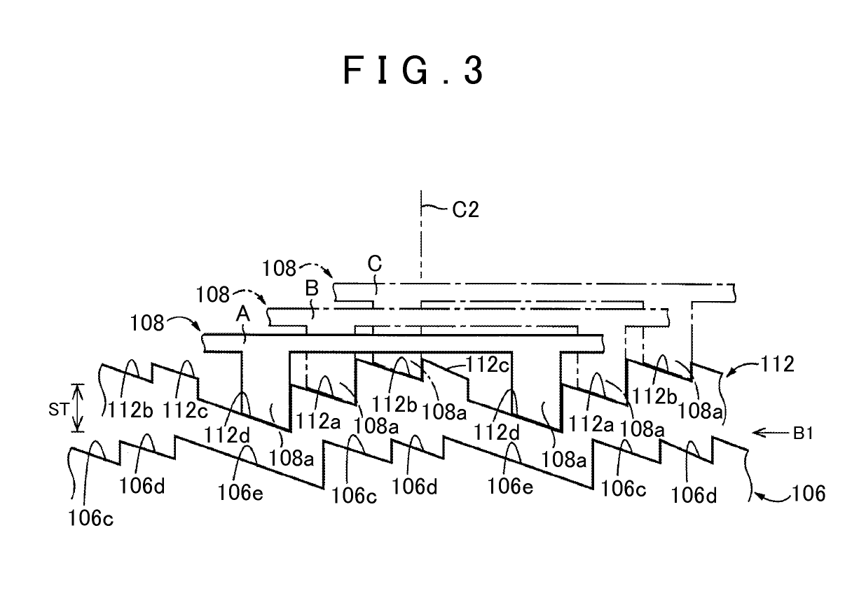

As shown in FIG. 2 and FIG. 3, the trip mechanism 104 includes a cylindrical first reciprocating member 106, an annular second reciprocating member 108, a spring 110 and an annular latch member 112. The cylindrical first reciprocating member 106 integrally protrudes from the output-side annular member 102b of the first thrust conversion mechanism 102, and has sawteeth at the end of the first reciprocating member 106. The first reciprocating member 106 is reciprocated in the cylindrical thrust direction together with the output-side annular member 102b in response to excitation of the first electromagnet 94. The annular second reciprocating member 108 is provided on the inner shaft 76 so as to be relatively rotatable around the rotation axis C3, and is actuated in the thrust direction by being pressed by the first reciprocating member 106. The spring 110 urges the second reciprocating member 108 away from the first reciprocating member 106. The annular latch member 112 has multi-step latch teeth, and is provided on the inner shaft 76 by spline fitting so as to be relatively non-rotatable and non-movable in the direction of the rotation axis. The annular latch member 112 latches the second reciprocating member 108 at a predetermined stroke end with any one of the multi-step latch teeth each time the first reciprocating member 106 is moved. The annular latch member 112 latches the second reciprocating member 108 as a result of a predetermined number of movements of the first reciprocating member 106 such that the reaction member 90 that moves together with the second reciprocating member 108 is located at the reaction force generating position. The annular latch member 112 unlatches the second reciprocating member 108 as a result of a predetermined number of movements of the first reciprocating member 106, and causes the reaction member 90 to be located at the non-reaction force generating position under the urging force of the return springs 95. The reaction member 90 shown on the upper side with respect to the rotation axis C3 in FIG. 2 shows a state where the reaction member 90 contacts the main clutch 84 and is located at the reaction force generating position at which the reaction member 90 receives a reaction force from the main clutch 84. The reaction member 90 shown on the lower side with respect to the rotation axis C3 shows a state where the reaction member 90 is located at the non-reaction force generating position away from the main clutch 84 (the reaction force generating position) by the predetermined distance D.

FIG. 3 is a schematic view that illustrates the operation of the trip mechanism 104. FIG. 3 is a developed plan of the cylindrical first reciprocating member 106, annular second reciprocating member 108 and annular latch member 112. A plurality of sawteeth are periodically provided at the main clutch 84-side end of the first reciprocating member 106. The heights of the sawteeth sequentially vary. As shown in FIG. 3, a set of three sawteeth respectively having inclined faces 106c, 106d, 106e are periodically provided continuously in the circumferential direction. The second reciprocating member 108 is provided such that the second reciprocating member 108 is movable in the direction of the rotation axis C3 together with the reaction member 90 by contacting the reaction member 90 via a thrust bearing. A plurality of latch teeth 108a having the same heights are provided on the first thrust conversion mechanism 102 side of the second reciprocating member 108. The latch member 112 has a plurality of sawteeth having inclined faces 112a, 112b, 112c, 112d and having different heights. The plurality of sawteeth are periodically provided continuously in the circumferential direction. The plurality of sawteeth are used to latch the sawteeth 108a of the second reciprocating member 108. The sawteeth provided in the first reciprocating member 106 and the receiving teeth of the latch member 112 have mutually substantially similar shapes, and are located so as to be offset from each other by a half phase in the circumferential direction. As shown in FIG. 3, the latch member 112 and the second reciprocating member 108 are shown by intentionally shifting the latch member 112 and the second reciprocating member 108 from the first reciprocating member 106 in the direction of the axis C for the sake of easy understanding. In an initial state where the reaction member 90 is located at the non-reaction force generating position and the second reciprocating member 108 is located at the position indicated by A in FIG. 3, the inclined faces 106e are substantially flush with the inclined faces 112c. A stroke ST of the first reciprocating member 106 is indicated as a stroke from a base position B1 that is the lower end of the inclined face of each of the latch teeth 108a.

In the initial state, when the first reciprocating member 106 is reciprocated by the predetermined stroke ST for the first time in response to excitation of the first electromagnet 94, the latch teeth 108a of the second reciprocating member 108 are raised by the inclined faces 106e of the first reciprocating member 106. Thus, the latch teeth 108a cross over the distal ends of the receiving teeth having the inclined faces 112a against the urging force of the spring 110, slide onto the lowest ends of the inclined faces 112a of the receiving teeth, and are latched at that position. The position of the second reciprocating member 108 shown at B in FIG. 3 shows this state. Subsequently, when the first reciprocating member 106 is reciprocated by the stroke ST for the second time in response to excitation of the first electromagnet 94, the latch teeth 108a of the second reciprocating member 108 are raised by the inclined faces 106c of the first reciprocating member 106. Thus, the latch teeth 108a cross over the distal ends of the sawteeth having the inclined faces 112b against the urging force of the spring 110, slide onto the lowest ends of the inclined faces 112b of the sawteeth, and are latched at that position. Because of the position of the second reciprocating member 108, the reaction member 90 is located at the reaction force generating position. The position of the second reciprocating member 108 shown at C in FIG. 3 shows this state. When the first reciprocating member 106 is reciprocated for the third time by the stroke ST in response to excitation of the first electromagnet 94, the latch teeth 108a of the second reciprocating member 108 are raised by the inclined faces 106c of the first reciprocating member 106. Thus, the latch teeth 108a cross over the distal ends of the sawteeth having the inclined faces 112c against the urging force of the spring 110, slide onto the lowest ends of the inclined faces 112c of the sawteeth and then onto the lowest ends of the inclined faces 112d downstream of the inclined faces 112c, and are latched. Thus, the reaction member 90 is returned to the initial non-reaction force generating position. The position of the second reciprocating member 108 shown at A in FIG. 3 shows this state. In this state, as shown on the lower side with respect to the rotation axis C3 in FIG. 2, the reaction member 90 is located at the non-reaction force generating position away from the main clutch 84 by the predetermined distance D.

In a state where the reaction member 90 is located at the non-reaction force generating position away from the main clutch 84 by the predetermined distance D, because there is a large clearance between adjacent two of the outer clutch plates 78 and the inner clutch plates 82 that constitute the main clutch 84, the drag torque is reduced. In the two-wheel drive mode in which the first clutch 32 is released, when the second clutch 48 is set to such a released state and the power transmission members are disconnected from the rear wheels 16R, 16L, running resistance is reduced, so fuel efficiency is improved. The power transmission members for transmitting power to the rear wheels 16R, 16L include the propeller shaft 28, and the like. In this case, the second clutch 48 functions as the disconnect clutch.

However, in a state where the reaction member 90 is located at the reaction force generating position at which the reaction member 90 receives a reaction force from the main clutch 84, the outer clutch plates 78 and the inner clutch plates 82 that constitute the main clutch 84 are clamped by the torque control piston 86 and the reaction member 90, and the second clutch 48 is controlled to generate a transmission torque having a magnitude corresponding to the clamping force. A thrust of the torque control piston 86 is controlled by the torque control actuator 88. In this case, the second clutch 48, for example, functions as an electronically controlled coupling that controls the distribution ratio of driving torque between the front and rear wheels in order to stabilize the behavior of the vehicle in cornering, or the like.

The torque control actuator 88 includes an annular second electromagnet 116, a second electromagnetic pilot clutch 122 and a second thrust conversion mechanism 124. The annular second electromagnet 116 is fixed to the clutch housing 72 that is the non-rotating member. The second electromagnetic pilot clutch 122 generates a pilot torque in the following manner. A plurality of friction plates 118 are pressed by a second movable piece 120 that is attracted by the second electromagnet 116. The plurality of friction plates 118 are respectively spline-fitted to the clutch drum 74 and the inner shaft 76 so as to be stacked each other. The second thrust conversion mechanism 124 converts the pilot torque, generated by the second electromagnetic pilot clutch 122, to a thrust in the direction of the rotation axis C3, and transmits the thrust to the torque control piston 86 that presses the main clutch 84.

The second thrust conversion mechanism 124, as well as the first thrust conversion mechanism 102, includes an input-side annular member 124a, an output-side annular member 124b and spherical rolling elements 124d. The input-side annular member 124a is provided so as to be relatively rotatable around the rotation axis C3. A pilot torque that is generated from the second electromagnetic pilot clutch 122 in response to excitation of the second electromagnet 116 is transmitted to the input-side annular member 124a. The output-side annular member 124b is spline-fitted to the outer periphery of the inner shaft 76 so as to be relatively non-rotatable and movable in the direction of the rotation axis C3. Each of the spherical rolling elements 124d is sandwiched by those input-side annular member 124a and output-side annular member 124b in a state where part of the spherical rolling element 124d is accommodated in a corresponding pair of inclined cam grooves 124c. The inclined cam grooves 124c are provided on each of facing surfaces of those input-side annular member 124a and output-side annular member 124b. The groove bottom depth of each inclined cam groove 124c continuously changes in the circumferential direction. When the input-side annular member 124a and the output-side annular member 124b are relatively rotated as a result of transmission of the pilot torque from the second electromagnetic pilot clutch 122, the output-side annular member 124b is moved in the direction of the rotation axis C3, and outputs a thrust in the thrust direction to the torque control piston 86. The second thrust conversion mechanism 124 controls the thrust in the thrust direction to a transmission torque having a magnitude corresponding to an exciting current of the second electromagnet 116.

As described above, the second clutch 48 according to the present embodiment, which is one example of the multiple disc clutch device for a vehicle, includes the clutch drum 74, the inner shaft 76, the multiple disc main clutch 84 and the torque control actuator 88. The clutch drum 74 is provided so as to be rotatable around the rotation axis C3. The inner shaft 76 is provided inside the clutch drum 74 so as to be relatively rotatable around the rotation axis C3. The multiple disc main clutch 84 is provided such that the outer clutch plates 78 and the inner clutch plates 82 are alternately stacked each other. The outer clutch plates 78 are provided on the inner periphery of the clutch drum 74 so as to be relatively non-rotatable with respect to the clutch drum 74. The inner clutch plates 82 are provided on the outer periphery of the clutch hub 76a so as to be relatively non-rotatable with respect to the clutch hub 76a. The clutch hub 76a is provided at the middle portion of the inner shaft 76 so as to have a large diameter. The torque control actuator 88 includes the torque control piston 86 that presses the main clutch 84. The second clutch 48 is configured to control the driving torque that is transmitted between the first rotor and the second rotor in the power transmission path of the vehicle. The clutch drum 74 is coupled to the first rotor so as to be relatively non-rotatable. The inner shaft 76 is coupled to the second rotor so as to be relatively non-rotatable. The second clutch 48 includes the reaction member 90 and the reaction member actuating device 92. The reaction member 90 clamps the main clutch 84 in cooperation with the torque control piston 86 as follows. The reaction member 90 receives an axial pressing force, which is applied from the torque control piston 86 to the main clutch 84, at the reaction force generating position. The reaction force generating position is located at a side across the main clutch 84 from the torque control piston 86. The reaction member actuating device 92 positions the reaction member 90 between the reaction force generating position and the non-reaction force generating position. The non-reaction force generating position is farther from the main clutch 84 than the reaction force generating position. The non-reaction force generating position is located the predetermined distance D apart from the pressing force receiving position in the axial direction. Therefore, the reaction member 90 that sandwiches the main clutch 84 in cooperation with the torque control piston 86 by the torque control actuator 88, which presses the main clutch 84, is located at the non-pressing force receiving position by the reaction member actuating device 92 when the main clutch 84 is not activated. At the non-pressing force receiving position, the reaction member 90 is located the predetermined distance D away from the main clutch 84. Thus, because the drag torque of the second clutch 48 (multiple disc clutch device for a vehicle) is significantly reduced when the main clutch 84 is not activated, the fuel efficiency of the vehicle improves, and, even when the second clutch 48 is placed in the fully differential state when the main clutch 84 is not activated and, as a result, there is a large rotation difference, the durability of the second clutch 48 is ensured.

According to the present embodiment, the reaction member actuating device 92 of the second clutch 48 includes the first electromagnet 94, the first electromagnetic pilot clutch 100, the first thrust conversion mechanism 102 and the trip mechanism 104. The first electromagnetic pilot clutch 100 generates a pilot torque in the following manner. The friction plates 96 provided between the clutch drum 74 and the inner shaft 76 so as to be stacked each other are pressed by the first movable piece 98 that is attracted by the first electromagnet 94. The first thrust conversion mechanism 102 converts the pilot torque, generated by the first electromagnetic pilot clutch 100, to a thrust in the direction of the rotation axis C3, and outputs the thrust. The trip mechanism 104 moves the reaction member 90 to the reaction force generating position as a result of the predetermined number of inputs of the thrust from the first thrust conversion mechanism 102, and latches the reaction member 90 at the reaction force generating position. When the number of inputs of the thrust exceeds the predetermined number, the trip mechanism 104 unlatches the reaction member 90, and moves the reaction member 90 to the non-reaction force generating position. Therefore, as a result of multiple strokes of the first reciprocating member 106 that moves together with the first movable piece 98 that is attracted by the first electromagnet 94, the second reciprocating member 108 and the reaction member 90 that moves together with the second reciprocating member 108 are moved by a stroke longer than the stroke of first reciprocating member 106. Thus, the stroke of the reaction member 90 between the reaction receiving position and non-reaction receiving position of the reaction member 90 that receives the reaction force from the main clutch 84 is significantly elongated. Therefore, the clearance between the reaction member 90 and the main clutch 84 and the clearance between adjacent two of the outer clutch plates 78 and the inner clutch plates 82 are increased when the main clutch 84 is not activated. The outer clutch plates 78 and the inner clutch plates 82 constitute the main clutch 84 of which the reaction force is received by the reaction member 90, and are stacked each other. Thus, the drag torque is significantly reduced. The first electromagnet 94 that attracts the first movable piece 98 by a relatively small stroke has a relatively small axial length and a relatively small radial size. Thus, the size of the reaction member actuating device 92 that functions as an actuator for the reaction member 90 is reduced, so the mountability on the vehicle is improved.

According to the present embodiment, the trip mechanism 104 of the second clutch 48 includes the first reciprocating member 106, the second reciprocating member 108, the spring 110 and the latch member 112. The first reciprocating member 106 is reciprocated in the thrust direction together with the first movable piece 98 that is attracted by the first electromagnet 94. The second reciprocating member 108 is pressed by the first reciprocating member 106, and is actuated in the thrust direction. The spring 110 urges the second reciprocating member 108 toward the first reciprocating member 106. The latch member 112 has the multi-step latch teeth, and is provided on the inner shaft 76 so as to be relatively non-rotatable and non-movable in the direction of the rotation axis C3. The latch member 112 latches the second reciprocating member 108 at the predetermined stroke end with any one of the multi-step latch teeth each time the first reciprocating member 106 is moved. The latch member 112 latches the second reciprocating member 108 as a result of a predetermined number of movements of the first reciprocating member 106 such that the reaction member 90 coupled to the second reciprocating member 108 is located at the reaction force generating position. The latch member 112 unlatches the second reciprocating member 108 as a result of a predetermined number of movements of the first reciprocating member 106, and causes the reaction member 90 to be located at the non-reaction force generating position under the urging force of the spring 110. Thus, because the trip mechanism 104 is formed of the first reciprocating member 106, the second reciprocating member 108, the spring 110 and the latch member 112 that are circular tubular components having a relatively small diameter, the size of the second clutch 48 (multiple disc clutch device for a vehicle) is reduced, so the mountability of the second clutch 48 on the vehicle is improved.

According to the present embodiment, the torque control piston 86 and the torque control actuator 88 are provided. The torque control piston 86 is provided at a side across the main clutch 84 from the reaction member 90, and clamps the main clutch 84 in cooperation with the reaction member 90. The torque control piston 86 is provided such that the main clutch 84 is located between the torque control piston 86 and the reaction member 90 in the direction of the rotation axis of the main clutch 84. The torque control actuator 88 controls a transmission torque by applying a thrust to the torque control piston 86. The main clutch 84 generates the transmission torque by being clamped by the torque control piston 86 and the reaction member 90 located at the reaction force generating position. Thus, the thrust of the torque control piston 86 that clamps the main clutch 84 in cooperation with the reaction member 90 located at the reaction force generating position is controlled by the torque control actuator 88. Thus, there is an advantage in that the transmission torque of the second clutch 48 (multiple disc clutch device for a vehicle) is controlled to a desired torque.

According to the present embodiment, the torque control actuator 88 of the second clutch 48 includes the second electromagnet 116, the second electromagnetic pilot clutch 122 and the second thrust conversion mechanism 124. The second electromagnetic pilot clutch 122 generates a pilot torque in the following manner. The friction plates 118 are provided between the clutch drum 74 and the inner shaft 76 so as to be stacked each other. The friction plates 118 are pressed by the second movable piece 120 that is attracted by the second electromagnet 116. The second thrust conversion mechanism 124 converts the pilot torque, generated by the second electromagnetic pilot clutch 122, to a thrust in the direction of the rotation axis C3, and transmits the thrust to the torque control piston 86 that presses the main clutch 84. Therefore, because the size of the torque control actuator 88 is reduced, the size of the second clutch 48 (multiple disc clutch device for a vehicle) is reduced, so the mountability of the second clutch 48 on the vehicle is improved.

The four-wheel drive vehicle according to the present embodiment includes the front wheel driving force distribution unit (first driving force distribution unit) 26, the transfer 24 and the rear wheel driving force distribution unit (second driving force distribution unit) 30. The front wheel driving force distribution unit (first driving force distribution unit) 26 is used to transmit a diving force from the engine 12 (driving source) to the right and left front wheels (main drive wheels) 14R, 14L. The transfer 24 is provided in the front wheel driving force distribution unit 26, and outputs power to the rear wheels (auxiliary drive wheels) 16R, 16L. The rear wheel driving force distribution unit (second driving force distribution unit) 30 transmits power, input via the propeller shaft 28 coupled to the transfer 24, to the right and left rear wheels (auxiliary drive wheels) 16R, 16L. The second clutch (multiple disc clutch device for a vehicle) 48 according to the present embodiment is arranged in the power transmission path from the transfer 24 to at least one of the right or left rear wheels 16R, 16L. Therefore, in the two-wheel drive mode, the second clutch (multiple disc clutch device for a vehicle) 48 is not activated, with the result that the rear wheels 16R, 16L and the engine 12 are not coupled to each other (are disconnected from each other). Thus, the fuel efficiency of the vehicle is improved. In the four-wheel drive mode, the second clutch 48 is not activated, and a transmission torque is controlled, with the result that the behavior of the vehicle in, for example, cornering, or the like, is stably controlled.

The embodiment of the invention is described in detail with reference to the accompanying drawings. The invention is also applied to other embodiments.

For example, in the above-described embodiment, the FF-base vehicle including the front wheel driving force distribution unit 26 and the rear wheel driving force distribution unit 30 is employed. The invention is also applicable to an FR-base four-wheel drive vehicle, an RR-base four-wheel drive vehicle, or the like, as needed. In the FR-base four-wheel drive vehicle or the RR-base four-wheel drive vehicle as well, the second clutch 48 (multiple disc clutch device for a vehicle) is used to function as a clutch for controlling the distribution ratio of driving force between the front and rear wheels and a disconnect clutch.

In the second clutch 48 of the above-described embodiment, the electromagnetic reaction member actuating device 92 is used as an actuator for positioning the reaction member 90. Instead, an actuator of another type, such as a motor type and a hydraulic cylinder type, may be used.

The torque control piston 86 that presses the main clutch 84 is actuated by the electromagnetic torque control actuator 88. Instead, an actuator of another type, such as a motor type and a hydraulic cylinder type, may be used.

The differential gear unit is used in each of the front wheel driving force distribution unit 26 and the rear wheel driving force distribution unit 30 that are used in the four-wheel drive vehicle 10 according to the above-described embodiment. Instead, an electronically controlled coupling that is able to transmit a driving force while allowing a rotation difference between the right and left wheels may be used.

The above-described embodiments are only illustrative. The invention may be implemented in a mode including various modifications or improvements on the basis of the knowledge of persons skilled in the art.

1. A multiple disc clutch device for a vehicle, the vehicle including a first rotor and a second rotor, the first rotor being arranged in a power transmission path of the vehicle, the second rotor being arranged in the power transmission path of the vehicle, the multiple disc clutch device being arranged in the power transmission path of the vehicle so as to connect the first rotor to the second rotor or disconnect the first rotor from the second rotor, the multiple disc clutch device comprising:
a clutch drum provided so as to rotate around a rotation axis, the clutch drum being coupled to the first rotor;
an inner shaft provided inside the clutch drum, the inner shaft being provided so as to relatively rotate around the rotation axis with respect to the clutch drum, the inner shaft being coupled to the second rotor;
a main clutch provided such that an outer clutch plate and an inner clutch plate are alternately stacked each other, the outer clutch plate being provided on an inner periphery of the clutch drum so as not to relatively rotate with respect to the clutch drum, the inner clutch plate being provided on an outer periphery of the inner shaft so as not to relatively rotate with respect to the inner shaft;
a reaction member arranged on one side of the main clutch in a direction of the rotation axis, the reaction member being configured to generate a reaction force by receiving a pressing force in the direction of the rotation axis via the main clutch, the pressing force being applied from the other side of the main clutch in the direction of the rotation axis; and
a reaction member actuating device configured to position the reaction member between a reaction force generating position for causing the reaction member to generate the reaction force and a non-reaction force generating position, the non-reaction force generating position being farther from the main clutch than the reaction force generating position, and the non-reaction force generating position being a position that is located a predetermined distance apart from the reaction force generating position in the direction of the rotation axis.

2. The multiple disc clutch device according to claim 1, wherein
the reaction member actuating device includes a first electromagnet, a first electromagnetic pilot clutch, a first thrust conversion mechanism, and a trip mechanism,
the first electromagnetic pilot clutch is configured to generate a pilot torque when first friction plates are pressed by a first movable piece, the first friction plates being provided between the clutch drum and the inner shaft so as to be stacked each other, the first movable piece being attracted by the first electromagnet,
the first thrust conversion mechanism is configured to convert the pilot torque generated by the first electromagnetic pilot clutch to a thrust in the direction of the rotation axis, amplify the thrust and output the amplified thrust, and
the trip mechanism is configured to move the reaction member to the reaction force generating position as a result of a predetermined number of inputs of thrust from the first thrust conversion mechanism and then latch the reaction member at the reaction force generating position, and the trip mechanism is configured to, when the number of inputs of the thrust exceeds the predetermined number, unlatch the reaction member and then move the reaction member to the non-reaction force generating position.

3. The multiple disc clutch device according to claim 2, wherein
the trip mechanism includes a first reciprocating member, a second reciprocating member, a return spring, and a latch member,
the first reciprocating member is configured to reciprocate in a thrust direction together with the first movable piece,
the second reciprocating member is configured to be actuated in the thrust direction by being pressed by the first reciprocating member,
the return spring is configured to urge the second reciprocating member toward the first reciprocating member, and
the latch member has multi-step latch teeth, the latch member is provided so as not to relatively rotate with respect to the inner shaft and so as to not move in the direction of the rotation axis, the latch member is configured to latch the second reciprocating member at a predetermined stroke end with any one of the multi-step latch teeth each time the first reciprocating member is moved, the latch member is configured to latch the second reciprocating member as a result of a predetermined number of movements of the first reciprocating member such that the reaction member coupled to the second reciprocating member is located at the reaction force generating position, and the latch member is configured to unlatch the second reciprocating member as a result of a predetermined number of movements of the first reciprocating member and cause the reaction member to be located at the non-reaction force generating position under an urging force of the return spring.

4. The multiple disc clutch device according to claim 1, further comprising:
a torque control piston provided such that the main clutch is located between the torque control piston and the reaction member in the direction of the rotation axis, the torque control piston being configured to clamp the main clutch in cooperation with the reaction member; and
a torque control actuator configured to control a transmission torque by applying a thrust to the torque control piston, wherein
the main clutch is configured to generate the transmission torque by being clamped by the torque control piston and the reaction member located at the reaction force generating position.

5. The multiple disc clutch device according to claim 4, wherein
the torque control actuator includes a second electromagnet, a second electromagnetic pilot clutch, and a second thrust conversion mechanism,
the second electromagnetic pilot clutch is configured to generate a pilot torque when second friction plates are pressed by a second movable piece that is attracted by the second electromagnet, the second friction plates are provided between the clutch drum and the inner shaft so as to be stacked each other, and
the second thrust conversion mechanism is configured to convert the pilot torque generated by the second electromagnetic pilot clutch to a thrust in the direction of the rotation axis, amplify the thrust and transmit the amplified thrust to the torque control piston.

6. A vehicle comprising:
a first driving force distribution unit configured to transmit a driving force from a driving source to right and left main drive wheels;
a transfer provided in the first driving force distribution unit, the transfer being configured to output power to right and left auxiliary drive wheels;
a second driving force distribution unit configured to transmit power to the right and left auxiliary drive wheels, the power being input via a propeller shaft coupled to the transfer; and
the multiple disc clutch device according to claim 1, the multiple disc clutch device being arranged in a power transmission path from the transfer to at least one of the right and left auxiliary drive wheels.
